(19) United States
(12) Patent Application Publication
(10) Pub. No.: US 2005/0268501 A1
(43) Pub. Date: Dec. 8, 2005

(54) Activity scheduling device

(76) Inventor: Janet Feinstein, North Salem, NY (US)

Correspondence Address: FRISHAUF, HOLTZ, GOODMAN & CHICK, PC, 220 5TH AVE FL 16, NEW YORK, NY, 10001-7708, US

(21) Appl. No.: 10/861,279

(22) Filed: Jun. 3, 2004

(51) Int. Cl. G09D 3/00

(52) U.S. Cl. 40/110

(57) ABSTRACT

Activity scheduling device including a display board having sections demarcated from one another. Each section represents a period of time such as a day and includes subsections, each representing a portion of the period of time, for example, hours of the day. Indicators are provided, each indicative of an activity, and an attachment mechanism is provided to attach the indicators to the display board. The activity may take the form of a picture and/or text on one or both surfaces of a substrate forming the indicator. In use, indicators indicative of a specific activity are placed on the appropriate day and at the appropriate time at which the activity is scheduled.

### FIELD OF THE INVENTION

The present invention relates generally to an activity scheduling device which provides an indication of when activities are scheduled over a period of time and more specifically to an activity scheduling device for children which informs children of the order in which certain activities will occur to help the children understand the concept of time.

### BACKGROUND OF THE INVENTION

Calenders, in their basic form, provide written tables displaying days and months of the future. Many calendars are provided with some space surrounding the indicia corresponding to each day to enable memos to be written regarding activities scheduled for that day. Some calenders include compartments, pockets or pouches associated with each day to enable various items to be stored therein, which items might be indicative of activities scheduled for that day.

For example, U.S. Pat. No. 6,591,522 (Doss) describes a date cycling storage calender including multiple rows or storage trays, each including multiple compartments. Slots are defined in front of the compartments and date cards, i.e., numerical cards, can be placed therein. Other cards indicative of activities, e.g., soccer practice, dentist appointment, or events, e.g., birthdays, relating to each date can be placed behind the respective date card.

U.S. Pat. No. 3,911,606 (Hunkins) describes a calendar kit which includes reminder tabs to be inserted at appropriate days to serve as reminders for specific special events such as a birthday, a dental appointment and the like.

Other prior art relating to calendars which enable reminders of activities or events to be displayed includes U.S. Pat. No. 3,207,421 (Hunger et al.) which describes a calendar having a plurality of pockets for storing various items that would or could be associated with a particular date to remind the user to consume, for example, medicine.

Various calendars are also known for enabling children to learn the concept of time, i.e., the passage of days, weeks and months. In this regard, reference is made to U.S. Pat. No. 4,863,386 (Maxey) which describes a children's learning calendar including various cards. The purpose of the calendar is to enable a child to recognize and match various shapes and to understand the sequence and passage of days of the week.

U.S. Pat. No. 5,257,940 (Schaarschmidt) describes a children's educational calendar which includes various date plates that are mountable upon date spaces and which are of contrasting coloration and configuration for the education and amusement of the user. The date plate may also include a pocket for storage of, for example, a vitamin or medicine to be consumed on the corresponding day.

U.S. Pat. No. 4,384,855 (Walsh) describes an educational task recorder for a child. A one week calendar is shown which includes a portion to indicate particular tasks to be performed by a child on a daily basis. The calendar includes a marker such that the child can mark on the corresponding day when a particular task has been performed.

The cited prior art lacks an easy way to schedule activities over a period of time while enabling a child to readily identify which activities are scheduled and in what order.

### OBJECTS AND SUMMARY OF THE INVENTION

It is an object of the present invention to provide a new and improved activity scheduling device that can display different schedules of activities over a period of time.

It is another object of the present invention to provide a new and improved activity scheduling device for children which can display the child's activities and teach the child the concept of time.

It is still another object of the present invention to provide an activity scheduling device which provides an easy way to schedule activities over a period of time while enabling a child to readily identify which activities are scheduled and in what order.

In order to achieve the above objects and others, an activity scheduling device in accordance with the invention includes a display board defining a plurality of sections demarcated from one another. Each section is indicative of a period of time and includes subsections, each indicative of a subperiod of time. For example, if the period of time is a day, the subperiod of time can be a number of hours in the day or the morning, afternoon, evening or night time. To provide for activity scheduling, activity indicators are provided, each capable of representing one or more activities, and an attachment mechanism is provided to attach the indicators to the display board, and specifically to the sections or subsections thereof. The activity may be represented by a picture and/or text on one or both surfaces of a substrate constituting the indicators.

In one embodiment, the display board includes seven sections arranged in a horizontal row, each representing one day of the week, such that the display board represents a full week. Each section includes three vertically oriented subsections, an uppermost one for a morning period, an intermediate one for an afternoon period and a lowermost one for an evening period. It is possible to include indicia on the display board to show which subsection represents which portion of the day, for example, place a rising sun in the upper portion representing the morning period and the moon in the lower portion representing the evening period. Generally, the description below will refer to such a display board. However, the display board can include any number of sections and subsections and can represent other periods of time. In particular, when the display board is formed on a computer, the software program can be designed to allow any number of sections and subsections without physical limitations.

To use the activity scheduling device for small children, a parent/caregiver/teacher would place an indicator indicative of a specific activity on the appropriate day and at the appropriate time at which the activity is scheduled. Older children could place the indicators on the appropriate day and time without adult assistance.

For example, an indicator with a picture of a church would be placed on the section representing Sunday in the subsection thereof indicative of the morning period (the uppermost subsection). The subsection indicative of the afternoon period might be provided with an indicator indicative of a recreational activity such as a playground or soccer practice. The placement of indicators would continue over the course of the week. Once an activity is completed, the indicator indicative thereof is removed from the display board and may be placed on a strip connected to the display board, and which utilizes the same form of attachment as the indicators to the display board, or in a container, optionally connected or connectable to the display board. Instead of placing the indicator on the strip, the indicator could be repositioned on another time subsection or turned over and repositioned when the opposite side of the indicator is either blank, decorative or depicts another activity.

The display board may consist of a single substrate or piece of material with the sections being separated from one another by demarcation lines. Alternatively, the sections could each be formed from an individual substrate or piece of material and connected together in a line, e.g., by hook and loop fasteners, zippers, snaps, buttons and the like. In this manner, it becomes possible to start the week at any day and to enable the sections representing Saturday and Sunday to be placed adjacent one another or on opposite sides of the row. Another alternative would be to form the sections representing the weekdays as a single substrate and the sections representing Saturday and Sunday as separate substrates which could be placed together either at the beginning or the end of the weekday substrate or apart therefrom, with Sunday before the weekday substrate and Saturday after the weekday substrate.

The attachment mechanism for attaching the indicators to the display board may be formed entirely in the display board, entirely in the indicators or with cooperating attachment members, one type of attachment member being arranged on the display board and one or more mating attachment members on each indicator. For example, the display board can include magnets at certain locations, one or more in each subsection, and the indicators formed to include a metallic material. Alternatively, the display board could be formed to include a metallic material and magnets mounted on rear surfaces of the indicators (with the front surface containing pictures and/or text indicative of an activity). Optionally, to expand the use of the indicators, a different activity could be represented on the rear surfaces of the indicator and magnets mounted on the front surfaces of the indicators. Thus, the indicators would be reversible in use.

Regarding the cooperating attachment members, the display is board could be formed with strips or sections of hook fasteners while the indicators include strips or sections of cooperating loop fasteners on a rear, top, bottom or side surface (or vice versa). Instead of hook and loop fasteners, other cooperating attachment mechanisms could also be used, such as two-part snaps, buttons and holes, zippers, poppers and pegs and corresponding holes/slots. The display board could also be formed with a framework to slide the indicators into or pouches or pockets into which indicators can be placed.

Another embodiment of the activity scheduling device in accordance with the invention includes a plurality of pages each representing a period of time and defining a plurality of subsections, each subsection being indicative of a portion of the period of time represented by the section. The indicators are mounted onto the pages. A binder is connected to the pages and when fixed to the pages, a book is formed. Alternatively, the pages can be removably connected to the binder, e.g., hole-punching the pages and placing them into a three-ring binder.

Other and further objects, advantages and features of the present invention will be understood by reference to the following specification in conjunction with the annexed drawings.

### BRIEF DESCRIPTION OF THE DRAWINGS

The invention, together with further objects and advantages thereof, may best be understood by reference to the following description taken in conjunction with the accompanying drawings, wherein like reference numerals identify like elements, and wherein:

FIG. 1 is a schematic showing an activity scheduling device in accordance with the invention.

FIG. 2 is a cross-sectional view taken along the line 2-2 of FIG. 1 showing the manner in which indicators are connected to a display board.

FIG. 3 is a cross-sectional view taken along the line 2-2 of FIG. 1 showing another manner in which indicators are connected to the display board.

FIG. 4 is a cross-sectional view taken along the line 4-4 of FIG. 1 showing the manner in which two sections of the display board are connected together.

FIG. 5 is a perspective view of one type of indicator used in the activity scheduling device shown in FIG. 1.

FIG. 6 is a top view of another embodiment of an activity scheduling device in accordance with the invention.

FIG. 7 is a perspective view of another activity scheduling device in accordance with the invention shown in a storage configuration.

FIG. 8 illustrates a computer system that can generate and use an activity scheduling device in accordance with the invention.

FIG. 9 shows a screen on a computer that can be generated using the program illustrated in FIG. 8.

FIG. 10 is a schematic showing an activity scheduling device in accordance with another embodiment of the invention.

FIG. 11 is a schematic showing an activity scheduling device in accordance with still another embodiment of the invention.

FIG. 12 is a schematic showing an activity scheduling device in accordance with yet another embodiment of the invention.

FIG. 13 is a perspective view of another embodiment of an activity scheduling device in accordance with the invention.

### DETAILED DESCRIPTION OF THE INVENTION

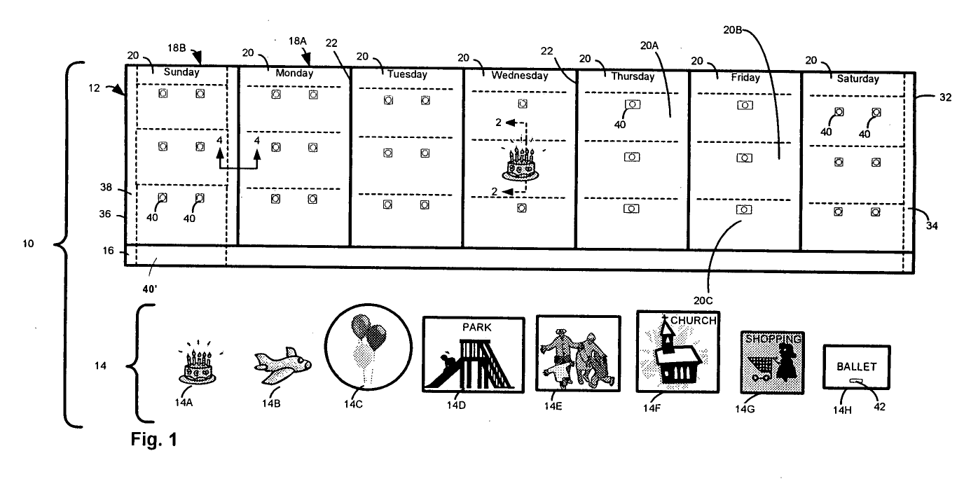

Referring to the drawings wherein like reference numerals refer to the same or similar elements, FIG. 1 shows an activity scheduling device in accordance with the invention which is designated generally as 10. The activity scheduling device 10 includes a display board 12 and a plurality of activity indicators 14 selectively attachable to the display board 12. A storage strip 16 is formed in conjunction with the display board 12, e.g., below the display board 12, for storing the activity indicators 14. The storage strip 16 could be formed integral with the display board 12 or as a separate component and attached to the display board 12 or maintained separately therefrom.

Display board 12 may be formed from a plurality of discrete sections of material 18A, 18B arranged in a horizontal row with each section of material 18A, 18B presenting one or more periods of time. As shown in FIG. 1, one section of material 18A includes six demarcated time sections 20 representing Monday through Saturday (and including a notation accordingly), with a demarcation line 22 between each adjacent pair of time sections 20, and another section of material 18B representing another time section 20, namely Sunday (and including a notation accordingly). This embodiment is constructed in this manner since it may be at time desired to have Saturday and Sunday on opposite ends of the weekdays (with the section of material 18B representing Sunday being at the extreme left of the horizontal rows of sections 20 representing Monday through Saturday as shown in FIG. 1) or adjacent one another with the section of material 18B containing the time section 20 representing Sunday being situated after the time section 20 representing Saturday. To this end (referring to FIG. 4), the left edge 24 of section 18A includes an attachment member 26 such as a strip of hook fasteners and the right edge 28 of section 18B includes a cooperating attachment member 30 such as a strip of loop fasteners. The connection of attachment members 26, 30 obtains the configuration of the activity scheduling device shown in FIG. 1. Instead of hook and loop fasteners as the attachment members 26, 30, other cooperating attachment mechanisms can be used, such as zippers, snaps, buttons, clips and the like.

To provide for the alternative configuration, the right edge 32 of section 18A, alongside the time section 20 representing Saturday, includes an attachment member 34 such as a strip of hook fasteners and the left edge 36 of section 18B includes a cooperating attachment member 38 such as a strip of loop fasteners. In this manner, the section 18B can be detached from its engagement with section 18A from the position shown in FIG. 1 and moved alongside the time section 20 representing Saturday and attached thereto by attachment members 34, 38. Instead of attachment members 34, 38, other attachment mechanisms can be used for attaching sections 18A, 18B together such as zippers, snaps, buttons, clips and the like.

It is also possible to form the display board 12 from individual sections of material, with each section representing a single period of time such as a day. In this case, each time section 20 would include an attachment mechanism along one or more side edges which enables its attachment to other sections in order to enable the formation of a horizontal row of sections 20 indicative of several consecutive days or a week. Moreover, it is possible to provide an attachment mechanism along the upper and lower edges of the sections to enable columns of sections to be provided. For example, with fourteen sections, it would be possible to represent two weeks whereby seven sections would be arranged in an upper row and seven sections in a lower row attached to the upper row. Additional weeks and months could also be formed in a similar manner by attachment mechanisms arranged on the edges of the individual sections.

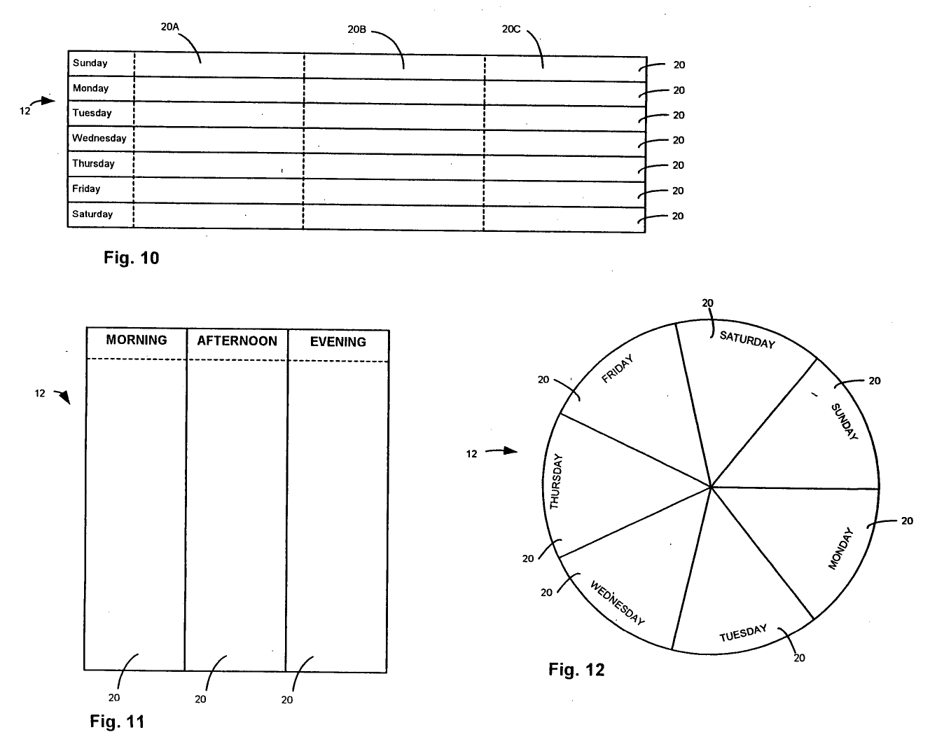

Instead of placing the time sections 20 in a horizontal row on the elongate display board 12 as shown in FIG. 1, the display board 12 can be designed to place time sections 20 in various linear or non-linear arrangements, such as in a vertical column, one above another as shown in FIG. 10. Each time section 20 would thus extend across the entire length of the display board 12. In a similar manner, it is possible to design a vertical display board 12 to have vertically oriented time sections 20 as shown in FIG. 11. Each time section 20 would therefore extend across the entire height of the display board 12. In yet another alternative, the display board 12 can be configured to provide a plurality of time sections 20 in a circular orientation as shown in FIG. 12.

Regardless of how a plurality of time sections 20 are placed into a horizontal row (or vertical column if so desired), each time section 20 preferably includes a plurality of subsections 20A, 20B, 20C which represents a specific subperiod of time within that time section 20 (see FIG. 1). For example, if each time section 20 represents a day, then three subsections can be provided, an uppermost one 20A representing a morning period, an intermediate one 20B representing an afternoon period and a lowermost one 20C representing an evening period.

Although the example shown in FIG. 1 defines the time section 20 as a day, with seven such time sections 20 being arranged in a horizontal row to define a week, and the subsections 20A, 20B, 20C of each time period 20 being the morning, afternoon or evening thereof, these time limitations can be varied as desired. The time period of each day might be presented by two hour blocks of time, e.g., one subsection representing 7-9 AM, the next 9-11 AM, the next 11 AM-1 PM, the next 1-3 PM, the next 3-5 PM and the next 5-7 PM. In this case, each time section 20 would include six subsections.

Similarly, the activity scheduling device 10 can be used to schedule activities for a single day, which might be useful in a camp or school setting with multiple activities throughout the day. In this case, a day can be partitioned into morning, afternoon and evening periods, with each period being represented by a time section 20, i.e., there would be three time sections in a horizontal row, one for the morning, one for the afternoon and one for the evening. Each time section could be partitioned into one or more subsections. For example, the time section representing the morning could be divided into subsections each representing one hour blocks of time, e.g., 7-8 AM, 8-9 AM, 9-10 AM, 10-11 AM and 11 AM-12 PM.

As such, the invention can thus be used to partition a time period (day, week, month) into a plurality of time sections in a horizontal direction and then each time section may be further partitioned into a plurality of time subsections in a vertical direction (or vice versa).

The extent to which the time period is partitioned into time sections and subsections depends on the intended use of the activity scheduling device 10. For children whose activities take a longer period of time, larger time subsections might be used whereas for older children and teenagers, smaller time subsections might be used to reflect a larger number of activities. The setting in which the activity scheduling device 10 is used may also affect the partitioning of the time period.

Referring back to FIG. 1, each activity indicator 14 is indicative of a specific activity, e.g., an activity indicator 14 may have a specific form or shape indicative of the activity, contain a picture indicative of the activity, contain text indicative of the activity, or a combination of any of the foregoing. As to activity indicators in the form or shape of an activity, the activity indicator may be in the shape of a birthday cake indicative of a birthday party (14A) or in the shape of an airplane indicative of a plane trip (14B). As to activity indicators which contain a picture indicative of the activity, such indicators include one having balloons indicative of a party (14C), one having playground equipment indicative of a trip to the park (14D), one having an older-looking couple indicative of an outing with grandparents (14E), one having a church indicative of religious services (14F) and one having a shopping cart and groceries indicative of a shopping trip (14G). An activity indicator including only text may be one that includes the word “BALLET” (14H).

Additional activities that may be represented by activity indicators 14 include baking (with a parent), a play date, watch a movie (with a parent), sports practice and arts and crafts.

An actual photo could also be placed on one or both sides of the indicator 14. For example, a photo of grandparents could be placed onto one side of an indicator 14 and used to indicate an outing with the grandparents. In this regard, a photo could be used as an indicator and provided with an attachment mechanism for use with the display board 12.

Reusable stickers can also be used as indicators 14, in which case, the adhesive on the stickers constitutes the attachment mechanism.

To enable use of the activity scheduling device 10 in accordance with the invention for visually impaired people, the indicia on the display board 12 and indicators 14 could include Braille lettering, raised letters and/or shapes, and physical and/or material characteristics, e.g., rough surfaces, smooth surfaces, bumpy surfaces.

The activity scheduling device 10 could be sold as a kit with the display board 12 and variety of different activity indicators 14 such as those shown in FIG. 1. However, to account for the fact that not all activities can be represented and that the same activity might be scheduled during the time period represented by the display board 12 more times than the number of activity indicators 14 provided indicative of that activity, blank activity indicators 14I may be provided in the kit such as shown in FIG. 5. The blank activity indicator 14I includes a substrate having a clear front surface (and optionally a clear rear surface) and is made of a material enabling indicia and/or coloring thereon and optionally, subsequent removal of the indicia and/or coloring. Thus, the child can draw on one or both surfaces of the activity indicator 14I, e.g., with crayons, pencil, pen or markers, an activity which is not represented by any of the activity indicators 14 provided and then once the activity is over, the drawing can be erased, washed off or wiped off to enable re-use of the activity indicator 14I. The child could also draw on the activity indicator 14I for fun or something relating to the weather and place the activity indicator on an open spot on the display board 12 where no other activity is scheduled. The blank activity indicator 14I could also be designed to be shaped or cut into a desired form or shape.

Instead of creating only a temporary indicia of the activity, permanent indicators can be created by applying iron-on pictures and/or text to one or both surfaces of the indicators or by drawing with permanent markers/ink on one or both surfaces of the indicators. It is also envisioned that photos can be printed onto one or both surfaces of the indicators

Some kits might be sold with only blank indicators 14. Optionally, stencils, templates and other materials for creating pictures of activities on the indicators 14, such as stickers, can be included in the kits. In addition, the kit could be sold as a craft requiring varying amounts of assembly and design work., which might appeal to older children.

The activity indicators 14 can be double-sided and formed with indicia of an activity on both sides, i.e., a different activity is depicted on each side. This expands the potential use of the activity indicators 14. In this case, each side of the activity indicator is attachable to the display board 12 in the manner described below.

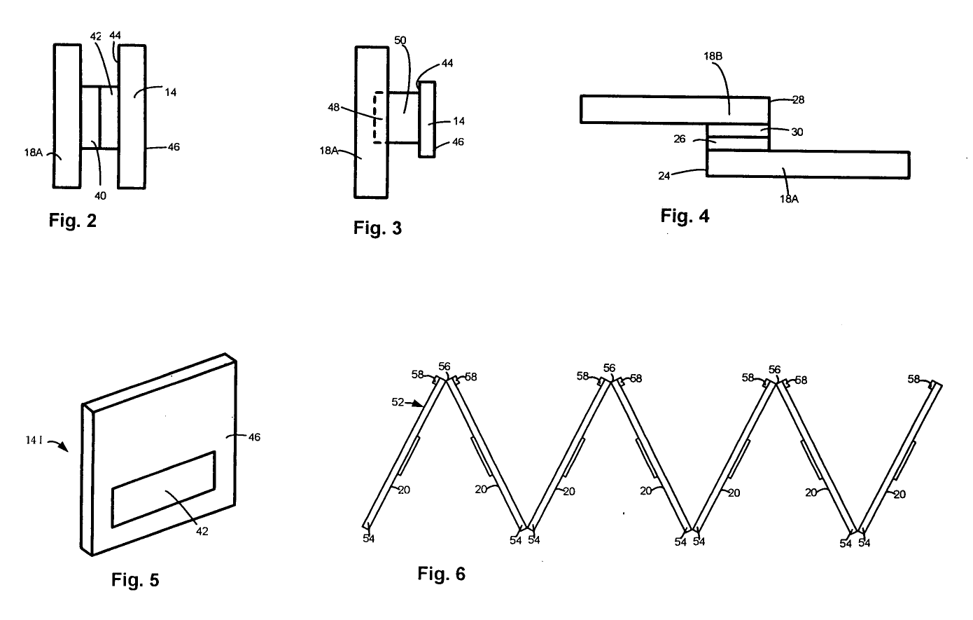

To attach the activity indicators 14 to the display board 12, a variety of different attachment mechanisms may be used. As shown in FIG. 2, one exemplifying attachment mechanism includes attachment members 40 arranged on the display board 12, and specifically one or more in each subsection 20A, 20B, 20C, and other cooperating or complementary attachment members 42 arranged on another surface of each indicator 14, e.g., a rear surface 44 of the indicator 14. For example, attachment member 40 could be a strip or section of hook fasteners while the attachment member 42 is a strip or section of loop fasteners. Instead of hook and loop fasteners, other cooperating or complementary attachment members include two-part snaps, buttons or pegs and holes, zippers and poppers.

As shown in the time sections 20 representing Saturday and Sunday in FIG. 1, multiple attachment members 40 can be arranged in each subsection 20A, 20B, 20C of the display board 12.

When the activity indicators 14 are double-sided, an attachment member 42 is arranged on both sides thereof (see activity indicator 14H in FIG. 1 wherein the front surface 46 includes both text indicative of an activity and attachment member 42-the rear side including different text and/or a picture and an attachment member 42 as well). Alternatively, the attachment members can be arranged on a top, bottom or side surface of the indicator.

FIG. 3 shows an alternative attachment mechanism in which the display board 12 includes a piece 48 made of a magnetically attractive material, i.e., a metallic material, and the activity indicator 14 includes a magnet 50 mounted on the rear surface 44. Alternatively, the display board 12 could be provided with magnets and the activity indicators with pieces of metallic material or formed entirely of metallic material.

To use the activity scheduling device 10 shown in FIG. 1, an activity indicator 14 indicative of a specific activity would be placed on the display board 12 on the appropriate section 20 and subsection 20A, 20B, 20C indicative of the day and time period in that day, respectively, at which the activity is scheduled. For example, an indicator with a picture of a school might be placed on the subsection 20A of the time periods 20 representing Monday through Friday. The placement of indicators 14 can be performed at the beginning of the week and once the activity is completed, the indicator 14 is removed. By removing the indicators 14 from each time period as the activity is completed, a child can appreciate the passage of time. However, if the activity indicator 14 is not removed, it can be used to review past activities with the child.

To store the activity indicators 14, the strip 16 includes the same type of attachment members 40′ as attachment members 40 in the display board 12 to enable them to engage with attachment members 42 on the activity indicators 14. For example, the strip 16 could include holes when the activity indicators 14 include pegs as the attachment members 42. Instead of strip 16, a separate bag or box could be provided in a kit with the display board 12 and activity indicators 14 to store the activity indicators 14 when not in use. Optionally, the bag or box can be attached to the display board 12 by hook and loop fasteners, or a pouch or pocket could be formed in the display board 12, e.g., on the side, bottom, top, front or back thereof.

Instead of forming the display board 12 from multiple sections of material 18A, 18B as shown in FIG. 1, it is possible to form the display board 12 from a single section of material to which one or more specific arrangements of time sections and subsections could be delineated or marked. Markers which delineate and designate the time sections and subsections could be removably attachable to the section of material to provide alternate configurations of the time sections and subsections of the display board 12.

Instead of forming the display board 12 from multiple sections of material 18A, 18B, it is possible to form the display board 12 from a single substrate 52 which has an accordion structure such as shown in FIG. 6. The substrate 52 may be formed to define the demarcated sections 54 (seven as shown so that each can be used to represent a day of the week) and may be folded about fold lines 56 for transport and storage purposes. Any conventional locking mechanism 58 may be attached to the rear of the substrate 52 along each fold line 56 to lock the substrate 52 in a closed position when unfolded and when released, and to enable the substrate 52 to be folded into a compact form.

It is also possible to form the display board from a number of individual pieces of material, for example seven, with each piece of material defining a time section and the pieces of material hingedly connected together to provide the display board with an accordion structure similar to that shown in FIG. 6. Any conventional locking mechanism is attached to the rear of the pieces of material to lock them together in a closed position when unfolded and when released, enable the display board to be folded into a compact form.

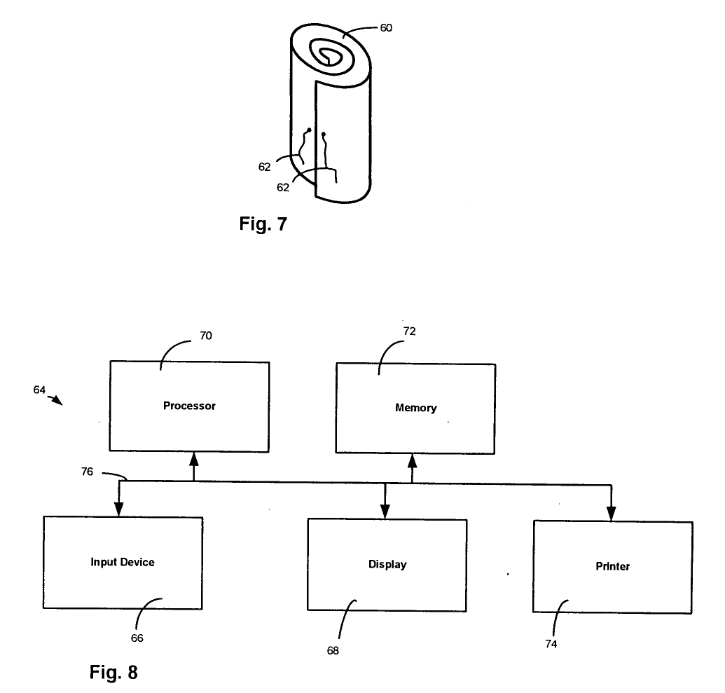

Another way to form the display board 12 is from a sheet of cloth or other rollable material 60 such as shown in FIG. 7. The cloth 60 can be formed with demarcation lines separating the sections 20 representing the different periods of time. In use, the cloth is unrolled and activity indicators 14 are placed thereon. The cloth 60 is rolled up for travel and storage purposes and secured in a closed configuration by straps 62. Instead of straps 62, other closures are possible such as hook and loop fasteners and snaps.

Any conventional mounting mechanism may be arranged on the rear surface of the display board 12 to enable the display board 12 to be mounted to a wall or other vertical structure. Instead of a wall-mounting mechanism, the display board 12 could be formed with a mechanism to enable it to stand freely on a table top or other horizontal surface, such mechanism being known in the art.

The display board 12 and indicators 14 may be formed from paper, poster board, cardboard, cloth, vinyl, plastic, wood, metal and quilted material. The attachment mechanism selected for the activity scheduling device 10 is of course compatible with whatever material is used to form the display board 12 and indicators 14. When a cloth such as felt is used to form the display board 12, the indicators 14 could be formed from a similar material which sticks to the cloth. In this case, the attachment mechanism would be the inherent properties of the display board 12 and indicators 14.

In one embodiment, the display board 12 could be formed from a magnetic material so that it can be mounted onto a refrigerator.

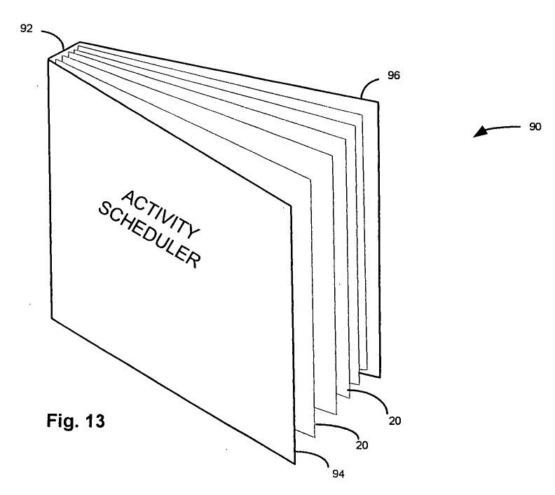

Referring now to FIG. 13, the display board 12 could be formed in a book format 90 with each section 20 being one page of the book 90 and the sections connected together by a binder 92 along one common lateral edge. Binder 92 has a cover 94 and back flap 96 and optionally includes a clasp or some other mechanism to keep the book 90 closed (in a similar manner as for some diaries and the like). Separate pages, with each page constituting one section, could also be formed and a folder provided to receive the pages in a removable manner, e.g., the pages could be hole-punched and a three-ring binder provided. In this manner, pages could be added and removed at will.

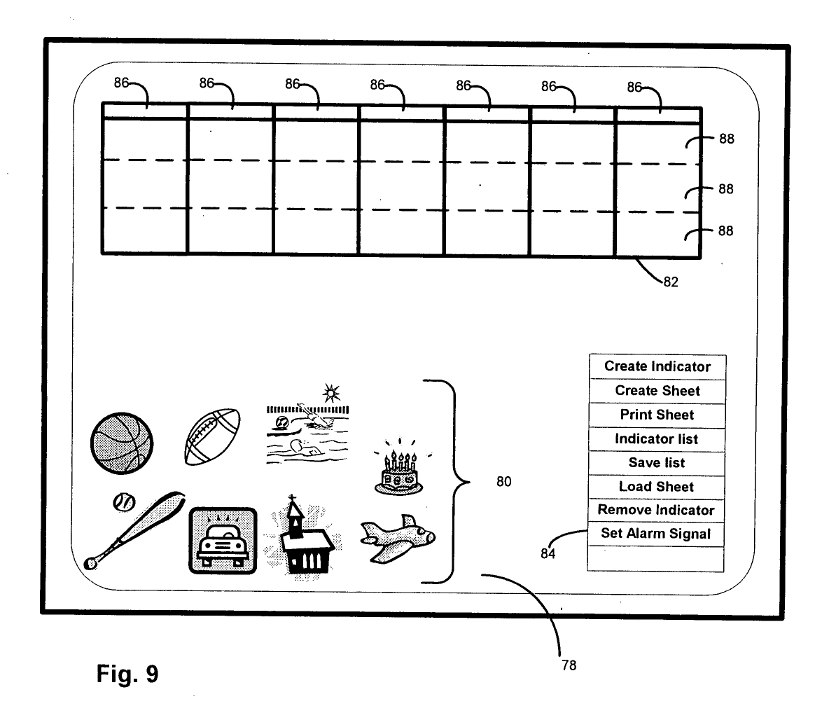

FIGS. 8 and 9 show an electronic embodiment of the activity scheduling device which may be embodied in software which runs in conjunction with hardware of a typical computer system 64. The computer system 64 includes one or more input devices 66 such as a keyboard or mouse for inputting data from a user of the computer system 64, a display 68 such as a monitor, a processor 70 for communicating with and driving the other elements of the computer system 64, a memory 72 for storing and retrieving data and optionally a printer 74 for outputting an activity scheduling sheet, all of which are connected together by a local interface 76 which may include one or more buses. Memory 72 may include various locations for storing data including a program and an operating system.

The program in memory 72 includes instructions or computer code written by a programmer for performing various functions relating to the activity scheduling program. These functions include those shown in the screen 78 in FIG. 9, for example, the ability to create and/or select indicators 80 and display them on the screen 78 of the display 68, the ability to create, select, save and load an activity scheduling sheet 82, the ability to print an activity scheduling sheet 82, the ability to remove indicators 80 from the activity scheduling sheet 82, the ability to set an alarm or signal, i.e., an audible and/or visual reminder when the time for an activity arrives, the ability to view possible indicators 80 and other functions described above which are performed when the physical activity scheduling device 10 is used, e.g., the ability to remove indicators from the activity scheduling sheet 82. Possible options are set forth in a drop-down menu of choices 84 displayed on the screen 78.

Any type of electronic display screen could be used as the screen 78 including a CRT, a plasma screen and a computer monitor screen.

To use the program, first, a user would create or select an activity scheduling sheet 82 by specifying the number of time sections 86 and the number of time subsections 88 in each time section 86. The program could be designed to allow for the insertion of text to each time section 86 and time subsection 88, such as the day represented by the time section 86 or the time period represented by the time subsection 88. The program could also be designed to enable control of the size of each time section 86 and subsection 88.

Once the activity scheduling sheet 82 is created or selected, the user looks at the list of previously generated indicators 80 and can designate some to show on the screen 78. The user can then click and drag the indicators 80 to a time subsection 88 on the activity scheduling sheet 82. The user can also create indicators 80 if none of the previously generated indicators 80 are appropriate for the activity. When the activity scheduling sheet 82 is completed, it can be saved and then retrieved later for reviewing and modifications (e.g., removal of an indicator 80 for an activity which has been completed). If desired, the activity scheduling sheet 82 can be printed out.

The program in memory 72 can be saved to a diskette, CD-ROM or other portable memory device and installed elsewhere for further use.

While the invention has been described above with respect to specific apparatus and specific implementations, it should be clear that various modifications and alterations can be made, and various features of one embodiment can be included in other embodiments, within the scope of the present invention. For example, the display board 12 could be formed in a variety of different (non-linear) shapes which are attractive to young children; for example, a cartoon character, a clown, a race car, a piece of sports equipment (baseball glove, baseball bat, baseball, soccer ball, basketball, hockey stick, hockey puck, ice skate), doll, ballerina, and teddy bear.

1. A activity scheduling device, comprising:
display means defining a plurality of sections demarcated from one another, each of said sections representing a period of time and defining a plurality of subsections, each of said subsections being indicative of a portion of the period of time represented by said section;
a plurality of indicators for mounting on said display means, said indicators containing indicia indicative of different activities; and
first attachment means for enabling said indicators to be removably attached to said display means.

2. The activity scheduling device of claim 1, wherein said sections are arranged in a horizontal row alongside one another and said subsections in each of said sections are vertically oriented one on top of another.

3. The activity scheduling device of claim 2, wherein each of said sections includes three of said subsections, an uppermost one of said subsections representing a morning period, a lowermost one of said subsections representing an evening period and an intermediate one of said subsections representing an afternoon period.

4. The activity scheduling device of claim 1, wherein display means comprise a single substrate with all of said sections being defined on said substrate.

5. The activity scheduling device of claim 4, wherein said substrate includes seven of said sections, each including a notation of a particular day of the week.

6. The activity scheduling device of claim 4, wherein said substrate is made of cloth and is rollable.

7. The activity scheduling device of claim 4, wherein said substrate includes fold lines to enable said substrate to be folded about said fold lines into a compact form.

8. The activity scheduling device of claim 1, wherein said display means comprise a plurality of substrates with each of said sections being formed on a respective one of said substrates, further comprising second attachment means arranged on said sections for attaching said sections together.

9. The activity scheduling device of claim 8, wherein said plurality of substrates consists of seven substrates each including a notation of a particular day of the week

10. The activity scheduling device of claim 1, wherein said material is selected from a group consisting of cloth, plastic, wood, metal and cardboard.

11. The activity scheduling device of claim 1, wherein said first attachment means comprise first attachment components arranged on said display means and second attachment members arranged on said indicators.

12. The activity scheduling device of claim 11, wherein said first attachment members are one of hook and loop fasteners and said second attachment members are the other of hook and loop fasteners.

13. The activity scheduling device of claim 1, wherein said first attachment means comprise a magnet arranged on each of said indicators, said display means including a magnetized material.

14. The activity scheduling device of claim 1, wherein said indicators each include a substrate having a front surface and a rear surface arranged to face said display means when attached thereto, said front surface of said indicators being made of a material enabling coloring thereon.

15. The activity scheduling device of claim 1, wherein said indicators each include indicia indicative of an activity.

16. The activity scheduling device of claim 15, wherein said indicia is pictorial.

17. The activity scheduling device of claim 15, wherein said indicia is textual.

18. The activity scheduling device of claim 1, further comprising a storage member for storing said indicators.

19. The activity scheduling device of claim 18, further comprising second attachment means for enabling said indicators to be removably attached to said storage member.

20. The activity scheduling device of claim 19, wherein said storage member comprises a strip connected to said display means.

21. The activity scheduling device of claim 18, wherein said storage member comprises a receptacle attachable to said display means.

22. An activity scheduling device, comprising:
a plurality of pages each representing a period of time and defining a plurality of subsections, each of said subsections being indicative or a portion of the period of time represented by said section;
a binder connected to said pages;
a plurality of indicators for mounting on said pages, said indicators containing indicia indicative of different activities; and
first attachment means for enabling said indicators to be removably attached to said pages.

23. The activity scheduling device of claim 22, wherein said pages are fixed to said binder to form a book.

24. The activity scheduling device of claim 22, wherein said pages are removably connected to said binder.

25. A computer program embodying software to perform the following steps:
enable creation or selection and display of an activity scheduling sheet on a display with demarcated sections arranged alongside one another and a plurality of subsections in each section;
enable creation or selection and display of indicators indicative of different activities; and
enable manipulation of the indicators onto the activity scheduling sheet into specific subsections.

26. The computer program of claim 25, wherein said software is further arranged to enable saving and retrieval of saved activity scheduling sheets.

27. The computer program of claim 25, wherein said software is further arranged to enable printing of activity scheduling sheets.
